(19) United States
(12) Patent Application Publication
(10) Pub. No.: US 2008/0261002 A1
(43) Pub. Date: Oct. 23, 2008

(54) Reflective Camouflage Material

(76) Inventor: Alexander Sloot, Sugarloaf, PA (US)

Correspondence Address: ST. ONGE STEWARD JOHNSTON & REENS, LLC, 986 BEDFORD STREET, STAMFORD, CT, 06905-5619, US

(21) Appl. No.: 11/737,526

(22) Filed: Apr. 19, 2007

(51) Int. Cl. B32B 27/14

(52) U.S. Cl. 428/198

(57) ABSTRACT

A camouflage material comprising a reflective layer disposed beneath a camouflage layer. The camouflage layer includes a plurality of spots forming a camouflage pattern. The camouflage layer is also characterized by the ability of light to transmit through a portion of the camouflage layer and reflect off of the reflective layer.

### FIELD OF THE INVENTION

This invention relates to camouflage materials, more particularly to camouflage materials that incorporate a reflective surface.

### BACKGROUND OF THE INVENTION

Camouflage materials are commonly used to conceal surfaces on individuals and vehicles in a natural environment, such as a wooded area. To achieve these objective these camouflage materials incorporate spotted patterns with colors that are associated with the natural environment. In a desert environment, such colors are lighter and may include white, tan, and light browns. In a wooded environment, such colors are darker and may include green, brown and black.

While camouflage is typically associated with the military, it is also used in recreation. For many outdoor activities, such as paintball, All Terrain Vehicle (ATVs) riding, and mountain biking, it is common for participants to wear camouflage and similar dark clothing. Further such activities typically take place in wooded areas and during the daytime. At night these individuals leave the wooded area and go to their next destination. In the context of ATVs and mountain bikes, these participants ride their vehicles on public streets and are not always readily identifiable by motorists. This creates a dangerous situation for the participant.

What is needed is a camouflage material that permits concealment during the daytime and facilitates identification at night. It would be beneficial if such camouflage material were incorporated in an armband so that a user can transfer it from one use to the next. It would also be beneficial if such camouflage material were associated with a sticker so that it could be securely attached to an object, such as a vehicle. It would further be beneficial if the camouflage material were incorporated in all or a substantial part of the surfaces of a T-shirt, coat, jacket, sweatshirt, pants, shorts, hat or other clothing.

### SUMMARY OF THE INVENTION

These and other objects are achieved by providing a camouflage material with a reflective layer disposed beneath a camouflage layer. The camouflage layer comprises a plurality of spots forming a camouflage pattern. The camouflage layer is further characterized such that light is able to transmit through a portion of the camouflage layer and reflect off of the reflective layer.

It is an aspect of the invention for the camouflage layer to further comprise a plurality of clear regions disposed between the plurality of spots.

It is another aspect for the spots to be printed on a transparent material such vinyl with a plurality of lines. The plurality of lines can be printed in the clear regions and given a shape and color that deemphasizes the reflective pattern during the daytime.

It is yet another aspect of the invention for the plurality of spots to be given a plurality of shapes and colors that correspond to a natural environment. Further, these spots can be oriented relative to one another so as to minimize the reflection of light by the reflective layer during the daytime and enable reflected light to be effectively viewed during the nighttime.

It is further an aspect of the invention to provide a camouflage material with a camouflage layer that comprises a plurality of spots forming a camouflage pattern on a surface of the camouflage layer and a plurality of light reflecting elements disposed on the surface of the camouflage layer. The light reflecting elements may comprise glass beads and/or reflective micro-prisms. The light reflecting elements may be formed on a transparent film that is adhered to the camouflage layer. Alternatively, the light reflecting elements may be applied to the camouflage layer utilizing an adhesive. The light reflecting elements formed on the transparent film or applied to the camouflage layer may be in the form of a reflecting pattern. The reflecting pattern may correspond to the camouflage pattern such that the reflecting pattern is deemphasized in the daytime, but emphasized when a direct light source is shined on the camouflage material.

It is still further an aspect of the invention for the camouflage material to be incorporated in a sticker, an armband, a T-shirt, coat, jacket, sweatshirt, pants, shorts, hat or other clothing. In the context of clothing, the camouflage material can form a significant part of such items.

These and other aspects of the invention and its particular features and advantages will become more apparent from consideration of the following drawings and accompanying description.

### BRIEF DESCRIPTION OF THE DRAWINGS

FIG. 1A is a perspective view of reflective camouflage material incorporated with a sticker.

FIG. 1B is a cross-sectional view of the reflective camouflage material of FIG. 1A with cut-out B.

FIG. 1C is a zoomed in view of cut-out B in FIG. 1B.

FIG. 2A is a depiction of a pattern base prior to the application of a camouflage pattern.

FIG. 2B is a top-down view of a portion of the pattern base of FIG. 2A with lines printed on a face of the base and a cut-out A.

FIG. 2C is a zoomed in view of cut-out A in FIG. 2B.

FIG. 2D is a top-down view of a portion of the pattern base of FIG. 2B with spots printed on the same face of the base as the lines.

FIG. 3A is an exploded view of an armband incorporating reflective camouflage material.

FIG. 3B is a cross-sectional view of the armband of FIG. 3A.

FIG. 3C is a perspective view of the armband of FIG. 3A and the layers of the camouflage material.

FIG. 3D is a view of the armband of FIG. 3A prior to the armband being applied to an arm.

FIG. 3E is a view of the armband of FIG. 3D applied to an arm.

### DETAILED DESCRIPTION OF THE INVENTION

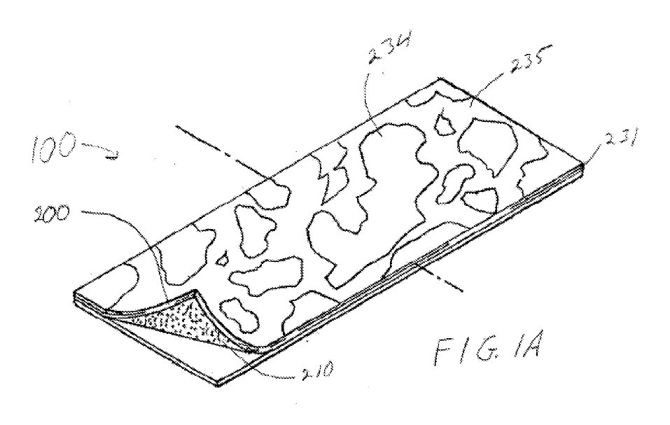

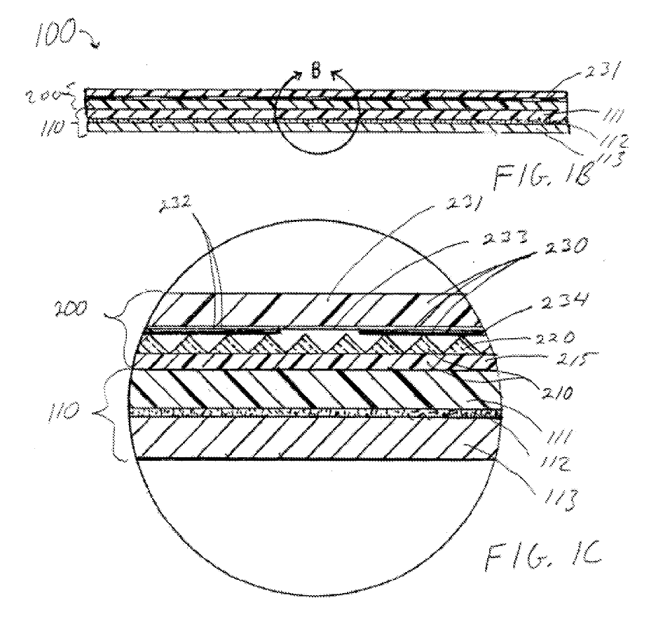

FIGS. 1A-1C depict a sticker 100 incorporating a camouflage material 200 that is reflective. Camouflage material 200 has a surface area that is sufficient to reflect direct light that is shown on the material in order for the reflected light to be adequately seen. Camouflage material 200 comprises reflective layer 210 positioned beneath a patterned layer 230. The combination of reflective layer 210 and patterned layer 230 provides a camouflage pattern and a reflective pattern dispersed amongst the camouflage pattern.

The reflective layer 210 serves as the base upon which camouflage material 200 will reflect light. Reflective layer 210 comprises a carrier film 215 and prisms 220. Carrier film 215 comprises a reflective surface that reflects incident light to the surface. Prisms 200 comprise a material through which light is refracted. This enables light incident to reflective layer 210 to be reflected at many angles, enhancing the visibility of the reflective layer from different angles. Depending on the application, this reflective layer 210 can be made of a rigid material, such as polycarbonate, or a flexible material such as vinyl. Moreover, other configurations of reflective layer 210 are possible, such as, for example, configurations incorporating beads rather than prisms. Further the reflective layer 210 can incorporate lighter colors, such as white or silver, to enhance the visibility of camouflage material 200.

Patterned layer 230 comprises a pattern base 231 and patterns 232. Base 231 is a clear sheet that is a transparent material, such as clear vinyl. Patterns 232 comprise lines 233 and spots 234 that are printed or painted on to the interior surface of pattern base 231 that abuts reflective layer 210. However, these patterns 232 could partially or entirely be formed on the exterior surface of pattern base 231. A characteristic associated with patterns 232 is that they may deter the transmittal of light to and from reflective layer 220.

Spots 234 are a series of printed shapes. The shapes of spots 234 are those commonly associated with camouflage patterns. Spots 234 are also given colors that correspond to the natural environment. In the context of a wooded environment, spots 232 can be a mixture of black, brown and green colors. Each spot can be given a solid uniform color or a combination of colors such that each spot has its own pattern. When spots 234 are given solid coloring, as opposed to transparent or translucent, light is inhibited from transmitting through spots 234 to reflective layer 210. As a result, these areas of camouflage material 200 are not reflective. There is a distinction between the traditional camouflage pattern and spots 234. In a traditional camouflage pattern each color region abuts the adjacent color region. FIG. 1 shows that some adjacent spots 234 abut one another while other adjacent spots 234 have a clear region 235 disposed in between such that the spots 234 are separated by the clear region 235. In these regions 235, patterns are not placed over base 231. These regions 235 comprise the clear material associated with base 231 and permit light to pass through to and from reflective layer 210. Of course, in embodiments where the spots 234 are colored with a transparent or translucent coating or ink, they may be positioned adjacent to one another without clear region 235 there between. The use of transparent or translucent spots 234 may be characterized by the fact that light is not inhibited or is partially inhibited from transmitting through spots 234. Spots 234 may be formed by methods such as screen printing, flexography, gravure, offset, digital and others.

Printed lines 233 are a series of thin printed marks that are dispersed within or over clear regions 235 and spots 234. When the printed lines 233 are dispersed over clear regions 235 they are also dispersed over the reflective pattern of the camouflage material. These lines 233 can be oriented in a random fashion relative to each other or in a pattern and can be continuous over several regions 235 and spots 234. Lines 233 can be dashed or contiguous and given a color that corresponds to a natural environment, such as tan or brown. Lines 233 assist in the camouflaged appearance of camouflage material 200 during the daytime. These lines 233 reduce the amount of light reflected by reflective layer 210 that passes through clear region 235 during the daytime, when most light is indirect. As a result, these lines are given a shape and color that deemphasizes the reflective pattern during the daytime. However, these lines are thin enough such that when a direct light source, such as a car light, is shined on the camouflage material 200, the material 200 is able to make the reflected light readily visible.

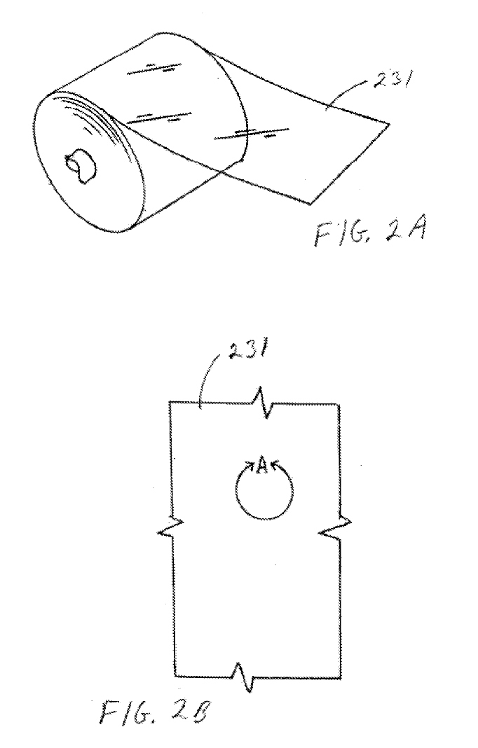

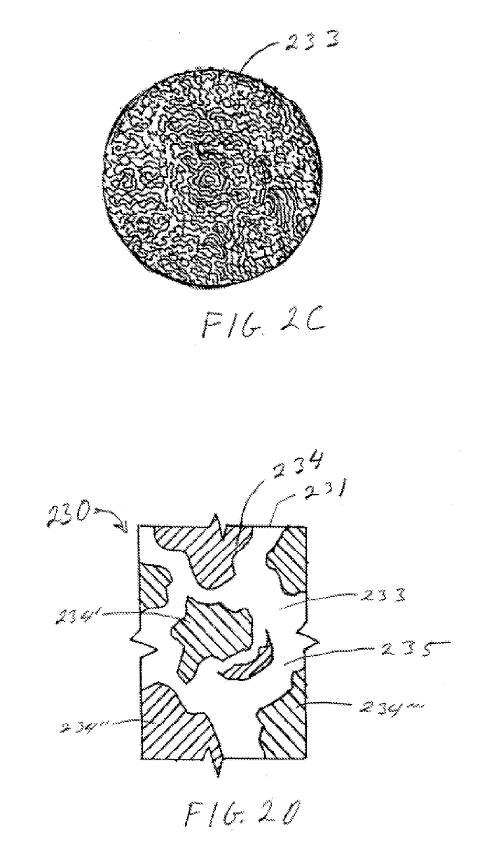

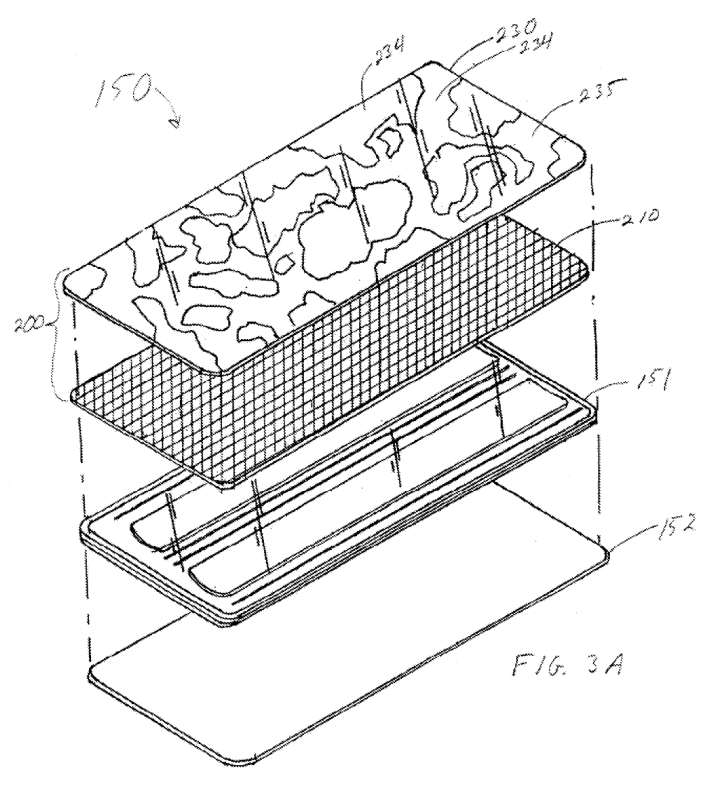

FIGS. 2A-2D depict the steps for manufacturing pattern layer 230. Pattern base 231 is a clear flexible plastic material such as clear vinyl. Gold or tan lines 233 are printed across the entire surface of pattern base 231. FIG. 2C depicts an enhanced view of cut out A from FIG. 2B. FIG. 2C shows that lines 233 are fine lines and are randomly oriented with kinks along the length of the lines. FIG. 2B also illustrates that from a distance, lines 233 are indistinguishable. After lines 233 are printed, spots 234 are printed on the same face of pattern base 231 as lines 233. Spots 234 comprise non-uniform or irregular shapes and are separated by clear regions 235. Lines 233 are disposed in clear regions 235 and spots 234. A plurality of colors can be associated with spots 234 so that camouflage material 200 may correspond to a natural environment. For instance, in a wooded environment, spot 234′ could be black, spot 234″ could be green, and spot 234′″ could be brown. These spots 234 may also be characterized by the fact that they prevent light from transmitting to or from a reflective layer. Optionally, spots 234 may be characterized by the fact that they permit the transmittance of light or inhibit the transmittance of light to or from a reflective layer.

The camouflage material optionally may be formed by providing a camouflage layer with spots forming a camouflage pattern on a surface of the camouflage layer. A reflecting layer can then be placed on top of the surface of the camouflage layer. The reflecting layer can be formed by incorporating light reflecting elements such as glass beads and/or reflective micro-prisms. One method is to couple the light reflecting elements to a transparent film and couple the film to the surface of the camouflage layer. Alternatively, the light reflecting elements may be applied directly to the camouflage layer utilizing an adhesive. The light reflecting elements formed on the transparent film or applied to the camouflage layer may be in the form of a reflecting pattern. Such a pattern may include spots or lines of reflecting elements. The reflecting pattern may also correspond to the camouflage pattern such that the reflecting pattern is deemphasized in the daytime, but emphasized when a direct light source is shined on the camouflage material.

In the context of a sticker 100 as shown in FIGS. 1A-C, camouflage material 200 is mounted to an adhesive tape 110. Adhesive tape 110 comprises an adhesive mount 111, adhesive layer 112, and adhesive release liner 113. FIG. 1C shows that adhesive mount 111 is coupled to reflective layer 210 on one face. Adhesive layer 112 comprises an adhesive or tacky substance and is applied to the other face of adhesive mount 111. Adhesive release liner 113 is secured to adhesive layer 112 and protects adhesive layer 112 before it is applied. When sticker 100 is to be applied to a vehicle, such as an ATV, adhesive release liner 113 is removed. Sticker 100 is applied to a vehicle surface and secured to the surface via adhesive layer 112. At nighttime, the light of an approaching vehicle will shine upon sticker 100. The light will transmit through pattern base 231. In the regions where spots 234 have been printed or applied, the light will be prevented from passing through to reflective layer 210. Light that passes through clear regions 235 and that does not engage lines 233 will pass through to reflective layer 210. Reflective layer 210 will then reflect a portion of the light back through clear region 235. This reflected light will be visible to the oncoming motorist and help identify the vehicle for the oncoming motorist.

Instead of a sticker, the camouflage material may be formed on a narrow tape or a wide sheet that is rolled for dispensing. A user unrolls the amount of camouflage material desired for application and severs that amount from the roll by means such as cutting. This enables variable sizes of the camouflage material to be selected for application. Further, the adhesive tape 110 or a portion thereof can be replaced by a layer of plastic or fabric. The plastic or fabric layer could be used to enable the camouflage material to be sewn onto clothing.

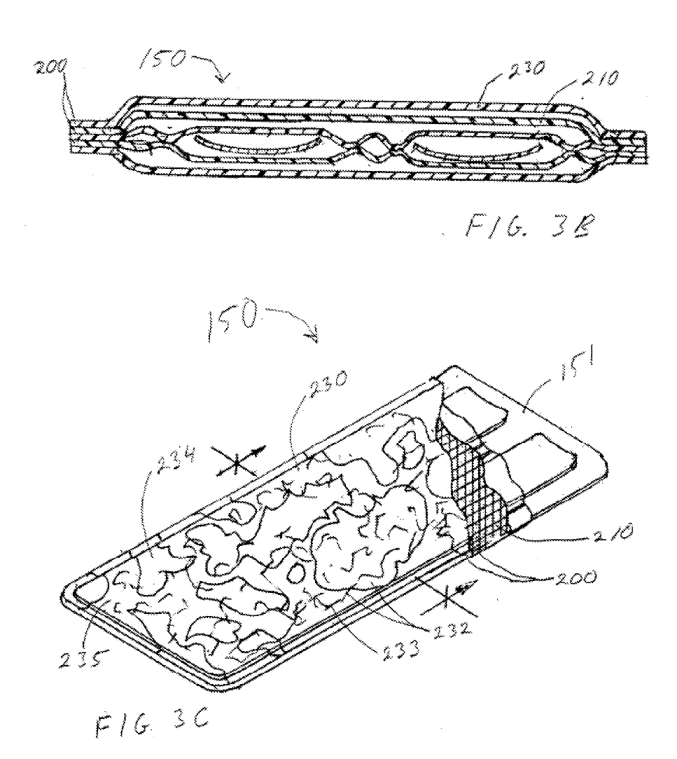

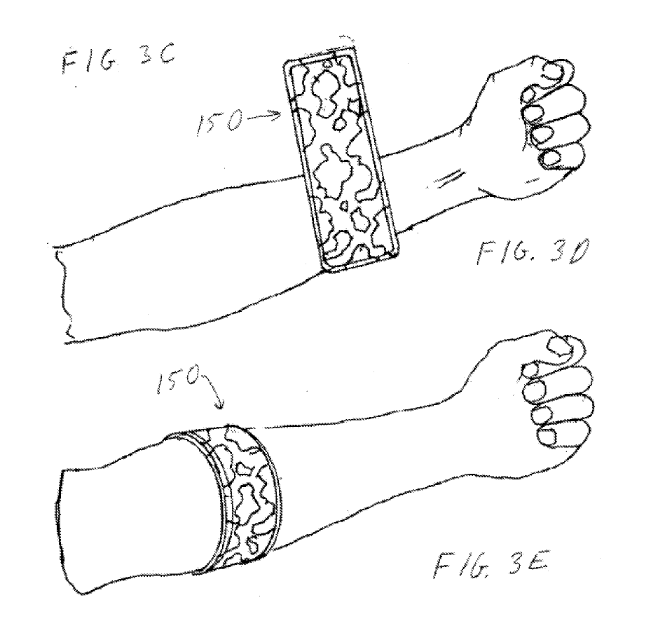

FIGS. 3A-E depict the use of camouflage material 200 with a spring action armband 150. The edges of camouflage material 200 are coupled to a metal band layer 151 and a plastic backing layer 152. Metal band layer 151 is disposed between reflective layer 210 and plastic backing layer 152. Camouflage material 200, reflective layer 210, and plastic backing layer 152 are coupled to each other about the corresponding edges of each layer via coupling means such as sonic welding, thermal pressing, or sewing. The metal band layer 151 allows armband 150 to be shaped such that the armband can be wrapped and secured to an arm. To remove the armband, the metal band layer 151 can simply be straightened out. The benefit of incorporating camouflage material 200 on an armband 150 is that it allows for the camouflage material 200 to be utilized by different persons and improves the overall flexibility of utilizing such a safety measure. Optionally, the plastic backing layer 152 can be of another material such as cloth or fabric. Further, a Velcro® type fastener optionally may be attached to the exterior surface of layer 152. Such a fastener would enable armband 150 to be further secured to a jacket or sweater. The use of a Velcro® type fastener also permits the metal band layer 151 to be excluded from armband 150.

The camouflage material optionally may be incorporated in a T-shirt, coat, jacket, sweatshirt, pants, hat or other clothing. With such clothing the camouflage material can form a significant part of the clothing. For t-shirts, coats, jackets, or sweatshirts, the camouflage material can cover all or a substantial portion of the exterior surface of a sleeve, the front, the back, or the side. For pants and shorts, the camouflage material can cover all or a substantial portion of the exterior surface of a leg. For caps, the camouflage material can cover all or a substantial portion of the exterior surface of a crown or brim.

Although the invention has been described with reference to a particular arrangement of layers and patterns, and materials used, these are not intended to exhaust all possible arrangements and materials, and indeed many modifications and variations will be ascertainable to those of skill in the art.

What is claimed is:

1. A camouflage material comprising:
a reflective layer disposed beneath a camouflage layer;
the camouflage layer comprising a plurality of spots forming a camouflage pattern; and
the camouflage layer characterized such that light is able to transmit through a portion of the camouflage layer and reflect off of the reflective layer.

2. The camouflage material of claim 1, wherein the camouflage layer further comprises a plurality of clear regions disposed between the plurality of spots.

3. The camouflage material of claim 2, wherein the plurality of spots are characterized such that light is inhibited from transmitting through the plurality of spots.

4. The camouflage material of claim 3, wherein the camouflage layer further comprises a plurality of lines.

5. The camouflage material of claim 4, wherein the camouflage layer further comprises a transparent material upon which the plurality of spots and plurality of lines are printed.

6. The camouflage material of claim 5, wherein the plurality of lines are printed in the plurality of clear regions.

7. The camouflage material of claim 6, wherein the plurality of lines are given a shape and color that deemphasizes the reflection of light during the daytime.

8. The camouflage material of claim 7, wherein the plurality of lines are oriented randomly.

9. The camouflage material of claim 8, wherein the plurality of spots are given a plurality of shapes and colors that correspond to a natural environment.

10. The camouflage material of claim 9, wherein the plurality of spots are separated by a distance that minimizes the reflection of light by the reflective layer during the daytime and enables reflected light to be effectively viewed during the nighttime.

11. The camouflage material of claim 10, wherein the camouflage layer and/or reflective layer are coupled to an armband, a sticker, a jacket, a shirt, a sweater, a hat, a narrow tape, a wide sheet, or pants.

12. The camouflage material of claim 1, wherein the plurality of spots are formed by a transparent or translucent coating or ink.

13. A camouflage material comprising:
a camouflage layer comprising a plurality of spots printed on the camouflage layer such that light is inhibited from transmitting through the camouflage layer in the location of the spots and a plurality of clear regions disposed between the plurality of spots through which light is able to transmit; and
a reflective layer coupled to a camouflage layer and disposed beneath the camouflage layer such that light transmitting through the clear regions of the camouflage layer is reflected off of the reflective layer and a portion of reflected light is able to transmit through the clear regions of the camouflage layer.

14. A camouflage material comprising:
a camouflage pattern; and
a reflective pattern dispersed amongst the camouflage pattern.

15. The camouflage material of claim 14, wherein the camouflage pattern comprises a plurality of spots.

16. The camouflage material of claim 15, wherein the plurality of spots are separated by the reflective pattern.

17. The camouflage material of claim 16, wherein the plurality of spots are formed on a transparent layer and the reflective pattern is formed on a reflective layer disposed beneath the transparent layer.

18. The camouflage material of claim 17, wherein clear regions are formed between the plurality of spots and the plurality of spots inhibit the transmission of light through the regions of the plurality of spots.

19. The camouflage material of claim 17, wherein the plurality of spots are formed by a transparent or translucent coating or ink.

20. The camouflage material of claim 14, wherein the reflective pattern is formed by a reflective layer disposed on top of the camouflage pattern.

21. The camouflage material of claim 14, wherein the reflective pattern comprises reflective elements that are coupled to a transparent layer.

22. The camouflage material of claim 14, wherein the reflective pattern comprises reflective elements that are coupled to the camouflage pattern.
